(19) United States
(12) Patent Application Publication
(10) Pub. No.: US 2012/0129363 A1
(43) Pub. Date: May 24, 2012

(54) ELECTRICAL CONNECTOR

(75) Inventors: Ching-Shun WANG, New Taipei City (TW); Chia-Ho CHANG, New Taipei City (TW)

(73) Assignee: Advanced Connection Technology, Inc., New Taipei City (TW)

(21) Appl. No.: 13/273,431

(22) Filed: Oct. 14, 2011

(30) Foreign Application Priority Data
Nov. 23, 2010 (TW) 099222691

(51) Int. Cl. H01R 12/71

(52) U.S. Cl. 439/83

(57) ABSTRACT

An electrical connector is applied to be soldered and disposed on a printed circuit board, and includes a terminal seat, a terminal and a soldering member. The terminal is disposed in the terminal seat, and includes a main body, a first clamping portion and a second clamping portion. The soldering member is clamped between the first clamping portion and the second clamping portion, and is soldered to the printed circuit board.

### CROSS-REFERENCES TO RELATED APPLICATIONS

This non-provisional application claims priority under 35 U.S.C. §119(a) on Patent Application No. 99222691 filed in Taiwan, R.O.C. on 2010 Nov. 23, the entire contents of which are hereby incorporated by reference.

### BACKGROUND OF THE INVENTION

1. Technical Field

The present invention relates to an electrical connector, and more particularly to an electrical connector having a soldering member clamped by a terminal.

2. Related Art

As more and more pins may be disposed on a central processing unit (CPU) with the development of process techniques, nowadays all CPU sockets adopt a Zero Insertion Force (ZIF) design. Please refer to FIG. 1, in which a conventional CPU socket electrical connector includes a terminal seat 10 and a plurality of terminals 20. The terminal seat 100 has a plurality of terminal slots 11. The plurality of terminals 20 is respectively disposed in the terminal slots 11. One end of the terminal 20 is a contact end 21, the other end of the terminal is a soldering end 22, and the soldering end 22 is recessed in the middle to form a cup shape, so that the soldering end 22 is soldered to a solder ball 30 and then soldered to a motherboard. Currently, the solder ball joining manner is the most commonly used method of soldering a CPU socket to a motherboard. However, to obtain the joined structure, the solder ball 30 is pre-soldered to each soldering end 22 by a jig, and then the CPU socket electrical connector is disposed on the motherboard and soldered by heating. Such a processing manner requires melting the solder ball 30 for the second time. When the solder ball 30 is soldered to the soldering end 20, a part of the solder flux contained in the solder ball 30 has been volatilized. As a result, when it is intended to solder the CPU socket electrical connector to the motherboard, the solder flux contained in the solder ball 30 is insufficient. In addition, when the solder ball 30 is melted for the second time, poor soldering is likely. Furthermore, as no fixing measures are taken when the solder ball 30 is placed at the soldering end 22 for subsequent soldering, it is easy for the solder ball 30 to fall off.

### SUMMARY

In view of the disadvantages of the electrical connector in the prior art that poor soldering is likely when the solder ball is melted for the second time and the solder ball easily falls off, the present invention provides an electrical connector, which is applied to be soldered and disposed on a printed circuit board, and includes a terminal seat, a terminal and a soldering member.

The terminal seat includes a terminal slot, formed through two opposite surfaces of the terminal seat, and accommodating the terminal and the soldering member.

The terminal is disposed in the terminal seat, and includes a main body, a first clamping portion and a second clamping portion. The first clamping portion extends from the main body and is bent. The second clamping portion extends from the main body in a direction opposite to the first clamping portion and is bent. The first clamping portion and the second clamping portion are arranged in a staggered manner and not in line.

The soldering member is clamped between the first clamping portion and the second clamping portion, and soldered to the printed circuit board.

The present invention further provides an electrical connector, which is disposed on a printed circuit board, and includes a terminal seat, a plurality of terminals, a plurality of soldering members and a connecting portion.

The terminal seat includes a plurality of terminal slots, formed through two opposite surfaces of the terminal seat, and each of the terminal slots accommodates one of the terminals and one of the soldering members.

The plurality of terminals is disposed in the terminal seat, and each of the terminals includes a main body, a first clamping portion and a second clamping portion. The first clamping portion extends from the main body and is bent. The second clamping portion extends from the main body in a direction opposite to the first clamping portion and is bent. The first clamping portion and the second clamping portion are arranged in a staggered manner and not in line. The first clamping portion of each of the terminals and the second clamping portion of another adjacent terminal are parallel side by side.

Each of the plurality of soldering members is clamped between the first clamping portion and the second clamping portion of one of the terminals, and soldered to the printed circuit board.

The connecting portion connects the plurality of terminals, so that the plurality of terminals is connected in parallel to form a string.

Through the technical means of the present invention, each of the terminals of the electrical connector can surely be connected to the printed circuit board by soldering through only one soldering procedure, and the soldering member to be soldered does not easily fall off from the positioning hole.

### BRIEF DESCRIPTION OF THE DRAWINGS

The present invention will become more fully understood from the detailed description given herein below for illustration only, and thus not limitative of the present invention, wherein:

FIG. 1 is a schematic view of an electrical connector in the prior art;

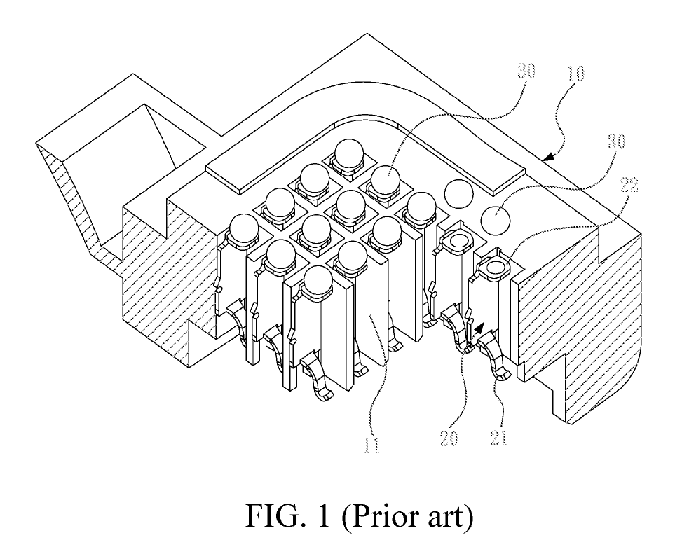

FIG. 2 is a schematic view (I) of a first embodiment of the present invention;

FIG. 3 is a schematic view (II) of the first embodiment of the present invention;

FIG. 4 is a schematic view (III) of the first embodiment of the present invention;

FIG. 5 is a schematic view (IV) of the first embodiment of the present invention;

FIG. 6 is a schematic view (I) of a second embodiment of the present invention;

FIG. 7 is a schematic view (II) of the second embodiment of the present invention;

FIG. 8 is a schematic view (III) of the second embodiment of the present invention;

FIG. 9 is a schematic view (IV) of the second embodiment of the present invention; and

FIG. 10 is a schematic view (V) of the second embodiment of the present invention.

### DETAILED DESCRIPTION

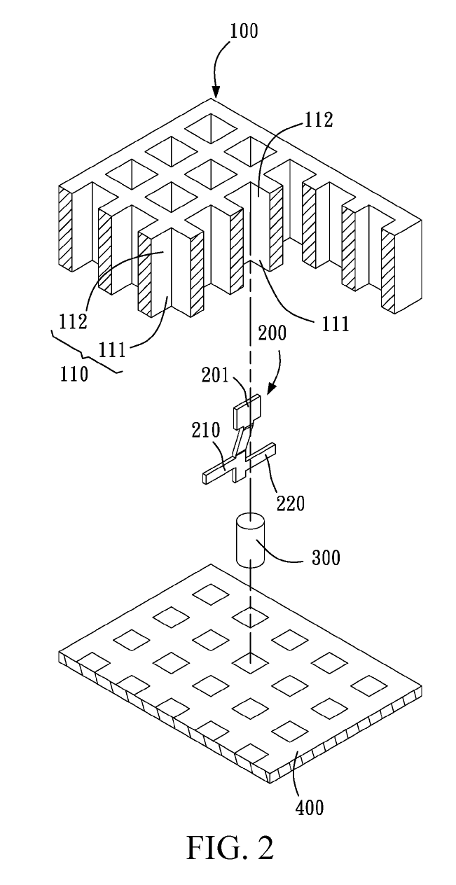

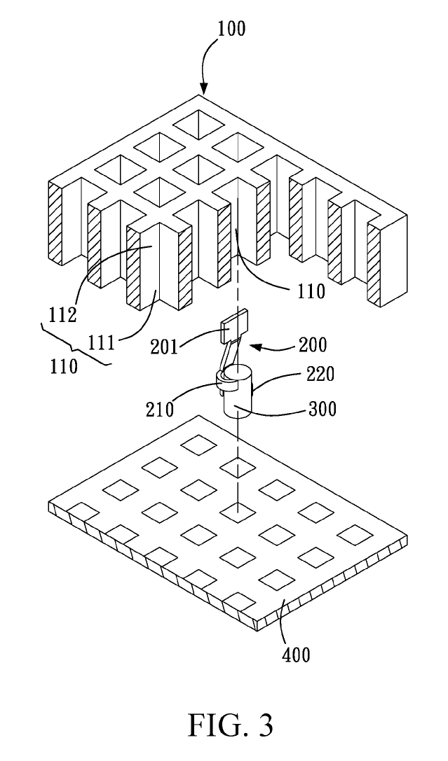

FIG. 2 and FIG. 3 are schematic views of a first embodiment of the present invention. Please refer to FIG. 2 and FIG. 3, in which the electrical connector of the present invention is disposed on a printed circuit board 400, and this embodiment includes a terminal seat 100, a terminal 200 and a soldering member 300.

The terminal seat 100 is in the shape of a flat plate, and includes a plurality of terminal slots 110. The terminal slots 110 are formed through two opposite surfaces of the terminal seat 100. Each of the terminal slots 110 is used for accommodating one of the terminals 200 and one of the soldering members 300. Two end openings of each of the terminal slots 110 are a board end 111 close to the printed circuit board 400 and an insertion end 112 away from the printed circuit board 400. The terminal is formed by stamping a metal sheet, and includes a main body 201, a first clamping portion 210 and a second clamping portion 220. The first clamping portion 210 extends from the main body 201. The second clamping portion 220 extends from the main body 201 in a direction opposite to the first clamping portion 210. The soldering member 300 is in the shape of a cylinder, made of a solder material, and disposed on the terminal 200.

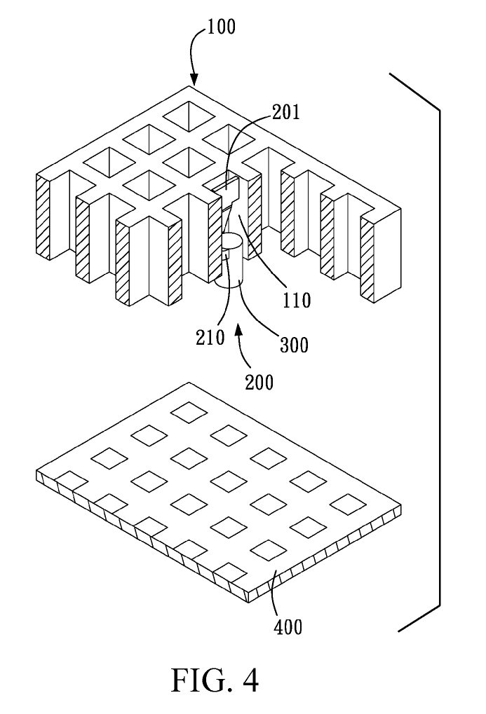

Please refer to FIG. 3, in which the first clamping portion 210 is bent towards the main body 201, and the second clamping portion 220 is bent towards the main body 201, so that the soldering member 300 is clamped between the first clamping portion 210 and the second clamping portion 220. Please refer to FIG. 4, in which the terminal 200 is aligned with one of the terminal slots 110, and inserted into the aligned terminal slot 100 from the board end 111 to the insertion end 112.

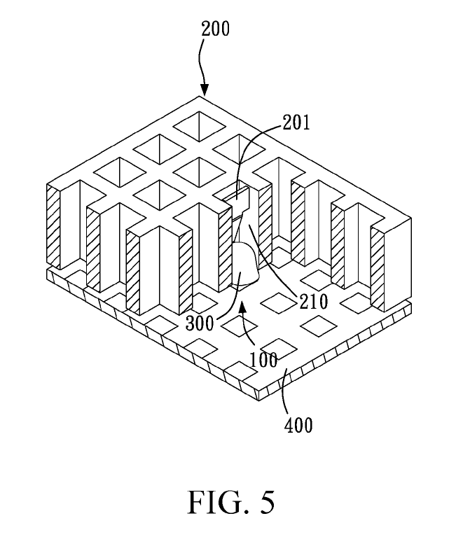

Please refer to FIG. 5, n which embodiment, the electrical connector of the present invention is disposed on a printed circuit board 400. The soldering member 300 is in contact with the printed circuit board 400, and once the electrical connector of the present invention and the printed circuit board 400 are heated by a soldering stove so that the soldering member is melted, the soldering member 300 is soldered to the printed circuit board 400, thereby soldering the electrical connector of the present invention to the printed circuit board 400.

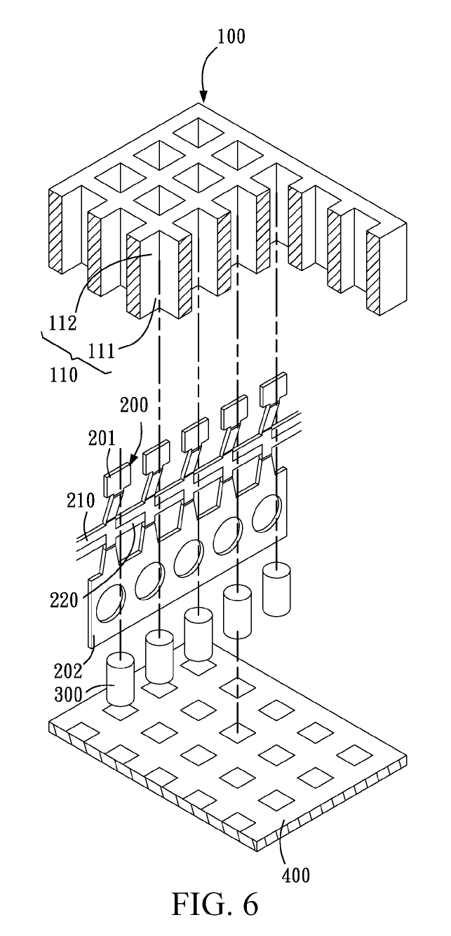

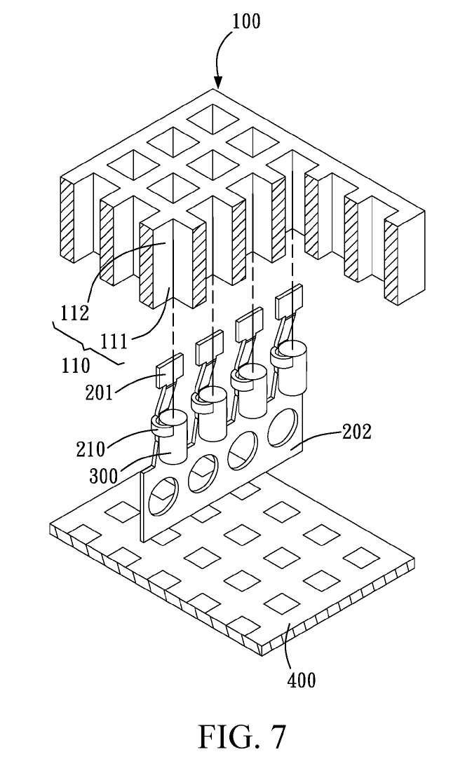

FIG. 6 and FIG. 7 are schematic views of a second embodiment of the present invention. Please refer to FIG. 6 and FIG. 7, in which the electrical connector of the present invention is disposed on a printed circuit board 400, and this embodiment includes a terminal seat 100, a plurality of terminals 200, a connecting portion 202 and a plurality of soldering members 300.

The terminal seat 100 is in the shape of a flat plate, and includes a plurality of terminal slots 110. The terminal slots 110 are formed through two opposite surfaces of the terminal seat 100. Each of the terminal slots 110 is used for accommodating one of the terminals 200 and one of the soldering members 300. Two end openings of each of the terminal slots 110 are a board end 111 close to the printed circuit board 400 and an insertion end 112 away from the printed circuit board 400.

The connecting portion 202 is a strip-shaped metal sheet formed by stamping. In this embodiment, the plurality of terminals 200 is arranged in parallel, and the terminals 200 are respectively connected to the connecting portion 202 so that the plurality of terminals 200 is connected to form a string. The terminal 200 is formed by stamping a metal sheet, and is preferably made of the same material as the connecting portion 202, so that the terminal 200 and the connecting portion 202 may be formed by stamping a metal plate for once. The soldering members 300 are in the shape of a cylinder and made of a solder material, and each of the soldering members 300 is disposed on one of the terminals 200.

Each of the terminals 200 includes a main body 201, a first clamping portion 210 and a second clamping portion 220. The first clamping portion 210 extends from the main body 201. The second clamping portion 220 extends from the main body 201 in a direction opposite to the first clamping portion 210. The second clamping portion 220 and the first clamping portion 210 are arranged in a staggered manner and not in line, so that when the plurality of terminals 200 is parallel side by side, the first clamping portion 210 of each of the terminals 200 and the second clamping portion 220 of another adjacent terminal 200 are staggered side by side. As the terminal slots are spaced from each other by a small interval, the side-by-side structure of the first clamping portions 210 and the second clamping portions 220 renders it unnecessary to preserve a large interval between the main bodies 201 of the terminals 200 for arranging the first clamping portions 210 and the second clamping portions 220 in order to conform to the interval between the terminal slots 110, thereby reducing material waste in the stamping process.

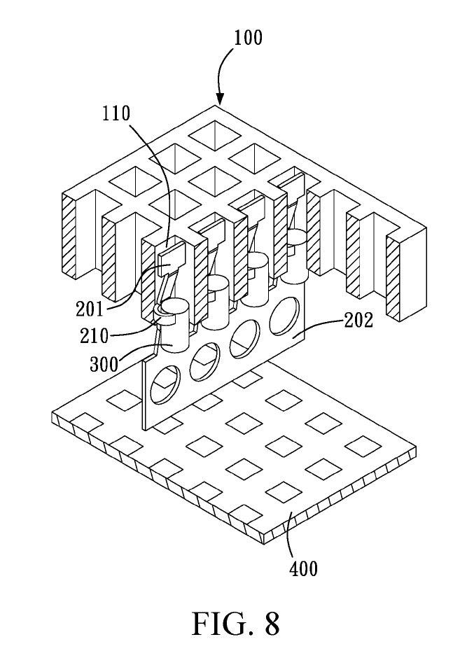

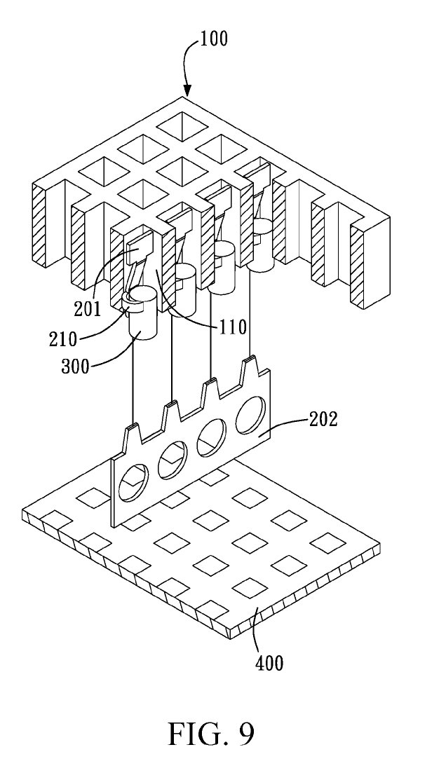

Please refer to FIG. 7, in which in each of the terminals 200, the first clamping portion 210 is bent towards the main body 201, and the second clamping portion 220 is bent towards the main body 201, so that the soldering member 300 is clamped between the first clamping portion 210 and the second clamping portion 220. Please refer to FIG. 8, in which each of the terminals 200 is aligned with one of the terminal slots 110, and each of the terminals 200 is inserted into the corresponding terminal slot 110 from the board end 111 to the insertion end 112. Please refer to FIG. 9, in which after the terminals 200 are inserted into the corresponding terminal slots 110, the connecting portion 202 is broken and removed.

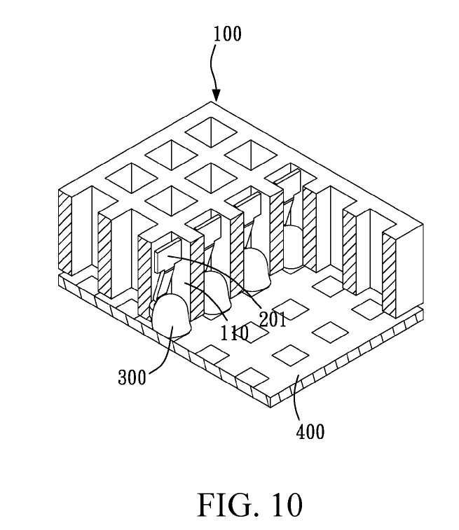

Please refer to FIG. 10, in which embodiment the electrical connector of the present invention is disposed on a printed circuit board 400. The soldering members 300 are in contact with the printed circuit board 400, and once the electrical connector of the present invention and the printed circuit board 400 are heated by a soldering stove so that the soldering members 300 are melted, the soldering member 300 are soldered to the printed circuit board 400, thereby soldering the electrical connector of the present invention to the printed circuit board 400.

Through the technical means of the present invention, each of the terminals 200 of the electrical connector can be connected securely_{[JB1]} to the printed circuit board 400 by soldering through only one soldering procedure, and as the soldering member 300 is fixed by the first clamping portion 210 and the second clamping portion 220, the soldering member 300 to be soldered does not easily fall off from the terminal slot 110, thereby effectively improving the process yield and reducing the processing cost.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An electrical connector, disposed on a printed circuit board, the electrical connector comprising:
a terminal seat;
a terminal, disposed in the terminal seat, the terminal comprising:
a main body;
a first clamping portion, extending from the main body and bent; and
a second clamping portion, extending from the main body in a direction opposite to the first clamping portion and bent; and
a soldering member, clamped between the first clamping portion and the second clamping portion, and soldered to the printed circuit board.

2. The electrical connector according to claim 1, wherein the first clamping portion and the second clamping portion are arranged in a staggered manner and not in line.

3. The electrical connector according to claim 1, wherein the terminal seat further comprises:
a terminal slot, formed through two opposite surfaces of the terminal seat, and accommodating the terminal and the soldering member.

4. An electrical connector, disposed on a printed circuit board, the electrical connector comprising:
a terminal seat;
a plurality of terminals, disposed in the terminal seat, each of the terminals comprising:
a main body;
a first clamping portion, extending from the main body and bent; and
a second clamping portion, extending from the main body in a direction opposite to the first clamping portion and bent; and
a plurality of soldering members, wherein each of the soldering members is clamped between the first clamping portion and the second clamping portion of one of the terminals, and soldered to the printed circuit board.

5. The electrical connector according to claim 4, wherein the first clamping portion and the second clamping portion are arranged in a staggered manner and not in line.

6. The electrical connector according to claim 4, wherein the first clamping portion of each of the terminals and the second clamping portion of another adjacent terminal are parallel side by side.

7. The electrical connector according to claim 4, wherein the terminal seat further comprises:
a plurality of terminal slots, formed through two opposite surfaces of the terminal seat, wherein each of the terminal slots accommodates one of the terminals and one of the soldering members.

8. The electrical connector according to claim 4, further comprising:
a connecting portion, for connecting the terminals, so that the terminals are connected in parallel to form a string.
